(19) United States
(12) Patent Application Publication
(10) Pub. No.: US 2015/0160984 A1
(43) Pub. Date: Jun. 11, 2015

(54) INFORMATION PROCESSING APPARATUS AND METHOD FOR CONTROLLING INFORMATION PROCESSING APPARATUS

(71) Applicant: FUJITSU LIMITED, Kawasaki-shi (JP)

(72) Inventor: Junichi INAGAKI, Kawasaki (JP)

(21) Appl. No.: 14/622,985

(22) Filed: Feb. 16, 2015

Related U.S. Application Data
(63) Continuation of application No. PCT/JP2012/070896, filed on Aug. 17, 2012.

(51) Int. Cl. G06F 9/50; G06F 13/24

(52) U.S. Cl. CPC G06F 9/5077; G06F 13/24; G06F 2209/5011

(57) ABSTRACT

An information processing apparatus including: a plurality of processors; and a setter that makes setting on the plurality of processors in conformity with a partition configuration, each of the plurality of processors including a port being connected to another processor and communicating with the connected other processor, the port including a first communicator that communicates with a processor belonging to a same partition as the processor including the port; a second communicator that communicates with a processor belonging to a different partition from the processor including the port; and a selector that selects a communicator from the first communicator and the second communicator in accordance with the setting of the setter and causes the selected communicator to communicate with the corresponding other processor. This configuration allows processors belonging to different partitions to efficiently communication with each other.

### CROSS-REFERENCE TO RELATED APPLICATION

This application is a continuation application of International Application PCT/JP2012/070896 filed on Aug. 17, 2012 and designated the U.S., the entire contents of which are incorporated herein by reference.

### FIELD

The embodiments discussed herein are an information processing apparatus and a method for controlling an information processing apparatus.

### BACKGROUND

A kind of an information processing apparatus such as a server is equipped with multiple Central Processing Units (CPUs), point-to-point connects the multiple CPUs to one another by means of a technique, such as Quick Path Interconnect (QPI) or Hyper Transport (HT), and has a physical partitioning function.

For example, an accompanying drawing FIG. 14 is a block diagram illustrating the basic configuration of an information processing apparatus (server) 100 having a physical partitioning function. The server 100 of FIG. 14 is equipped with four CPUs 101A-101D. One of the four CPUs is specified by one of the reference numbers 101A-101D, but an arbitrary CPU is represented by the reference number 101. Each CPU 101 includes two CPU interconnect ports 102 and the four CPUs 101A-101D are connected into a ring topology via the CPU interconnect ports 102 CPU and interconnect lines 103.

In the example of FIG. 14, the server 100 is divided into two physical servers by the physical partitioning function: two CPUs 101A and 101B are assigned to a partition #0 while the two remaining CPUs 101C and 101D are assigned to a different partition #1. Under this state, the CPU interconnect line 103 between the CPUs 101A and 101B in the partition #0 and the CPU interconnect line 103 between the CPU 101C and 101D in the partition #1 are ordinarily used. In contrast, the CPU interconnect lines 103 over the two different partitions #0 and #1, i.e., the CPU interconnect line 103 between the CPUs 101A and 101D and the line 103 between the CPUs 101B and 101C are unused even while establishing physical connections and are kept to be a state where outputs to the CPU interconnect lines 103 are saved or powered-off.

Data communication between the CPUs 101A and 101D segmented by the partitioning as illustrated in FIG. 14 is accomplished in the manners illustrated in one of FIGS. 15 and 16 without using the CPU interconnect line 103 between the CPUs 101A and 101D. Accompanying drawings FIGS. 15 and 16 are block diagrams illustrating examples of a manner of inter-partition communication.

In one example of FIG. 15, there is provided a Peripheral Components Interconnect express (PCIExpress (registered trademark); PCIe (registered trademark)) switch 104 subordinate to each CPU 101, and a Network Interface Card (NIC) 105 is placed into a card slot 104a of the PCIe switch 104. The NICs 105, 105 belonging to respective different partitions #0 and #1 are connected to each other via Ethernet (registered trademark). This configuration allows data communication between the CPUs 101A and 101D belonging to the different partitions #0 and #1, respectively.

In the other example of FIG. 16, there is provided a PCIe switch 104′ that is shared by the CPUs 101A and 101D belonging to the different partitions #0 and #1, respectively and that has a partitioning function and a Non-Transparent Bridge (NTB) port 104b. Data communication between the CPUs 101A and 101D belonging to the different partitions #0 and #1 is achieved by using the NTP ports 104b of the PCIe switch 104′. An NTB port has a function to share data between two different partitions or two different host devices according to the PCI specification, has a memory-mapped space in the port, and allows data communication between the partitions and the hosts by using the space.

The communication illustrated in FIG. 15 further needs two NICs 105 and a cable 106 to achieve the data communication between the two different partitions #0 and #1 while the communication illustrated in FIG. 16 needs the switch 104′ shared by the two different partitions #0 and #1. Either communication passes through the switch 104 (or 104′) and a network to carry out communication between the CPU 101A and the CPU 101D belonging to respective different partitions, and therefore results in less communication performance than communication using CPU interconnect. Despite the presence of an interface (i.e., the CPU interconnect line 103) low in latency but high in band width, communication between the CPUs 101 belonging to different partitions in the same server 100 has been accomplished through the NIC 105 and the PCIe switch 104 (104′) without using the CPU interconnect line 103, which greatly impairs the efficiency.

### SUMMARY

As one aspect of the embodiments, an information processing apparatus includes: a plurality of processors; and a setter that makes setting on the plurality of processors in conformity with a partition configuration. Each of the plurality of processors includes a port being connected to another processor and communicating with the connected other processor. The port of each processor includes a first communicator, a second communicator, and a selector. The first communicator communicates with a processor belonging to a same partition as the processor including the port. The second communicator communicates with a processor belonging to a different partition from the processor including the port. The selector selects a communicator from the first communicator and the second communicator in accordance with the setting of the setter and causes the selected communicator to communicate with the corresponding other processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating the main configuration of an information processing apparatus according to a first embodiment;

FIG. 2 is a block diagram schematically illustrating the entire configuration of an information processing apparatus applied thereto the main configuration of FIG. 1;

FIG. 3 is a flow diagram denoting functions of a setter of FIG. 2 and a selector of FIG. 1;

FIG. 4 is a block diagram illustrating a single-partitioned state of an information processing apparatus of FIG. 2;

FIG. 5 is a block diagram illustrating a two-partitioned state of an information processing apparatus of FIG. 2;

FIG. 6 is a block diagram illustrating a detailed configuration of an NTB port upper layer (second communicator) of FIG. 1;

FIG. 7 is a block diagram illustrating an address converting function of an address convertor in an NTB transaction layer of FIG. 6;

FIG. 8 is a diagram depicting the contents of a transaction ID;

FIG. 9 is a block diagram functions for tag conversion/inverse-conversion and transaction ID conversion/inverse-conversion by an address convertor in an NTB transaction layer of FIG. 6;

FIG. 10 is a block diagram illustrating a doorbell function and a scratchpad function of an NTB transaction layer of FIG. 6;

FIG. 11 is a diagram illustrating division and encapsulation of a packet by a CPU interconnect data link interface (second interface) of FIG. 6;

FIG. 12 is a block diagram illustrating the main configuration of an information processing apparatus according to a second embodiment;

FIG. 13 is a block diagram illustrating a detailed configuration of an NTB port upper layer (second communicator) of FIG. 12;

FIG. 14 is a block diagram illustrating a basic configuration of an information processing apparatus (server) having a physical partitioning function;

FIG. 15 is a block diagram illustrating an example of a manner of inter-partition communication; and

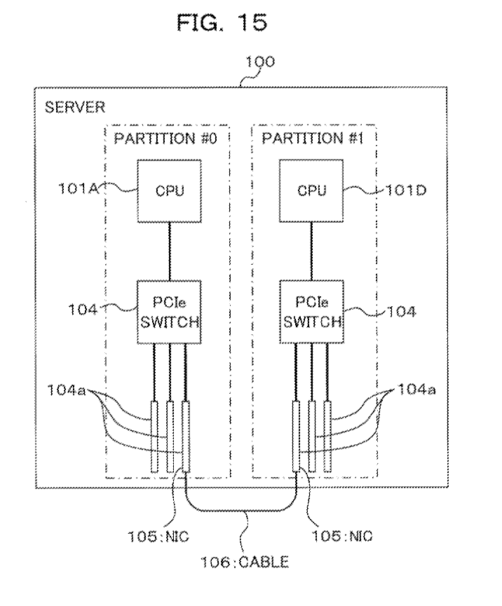

FIG. 16 is a block diagram illustrating another example of a manner of inter-partition communication.

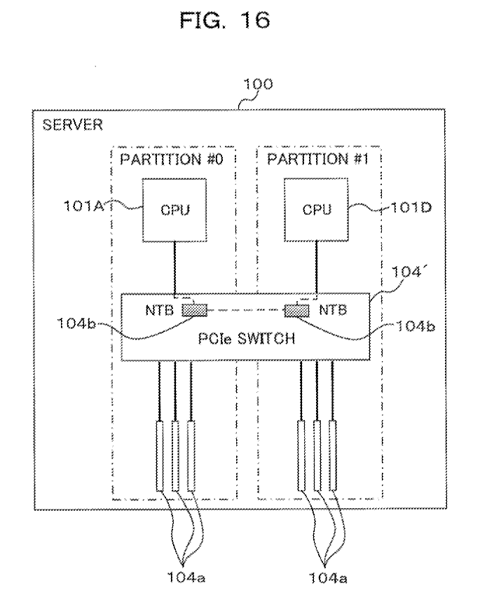

### DESCRIPTION OF THE PREFERRED EMBODIMENTS

Hereinafter, embodiments will now be described with reference to accompanying drawings.

(1) Information Processing Apparatus (Server) of a First Embodiment:

(1-1) Basic Configuration of the First Embodiment:

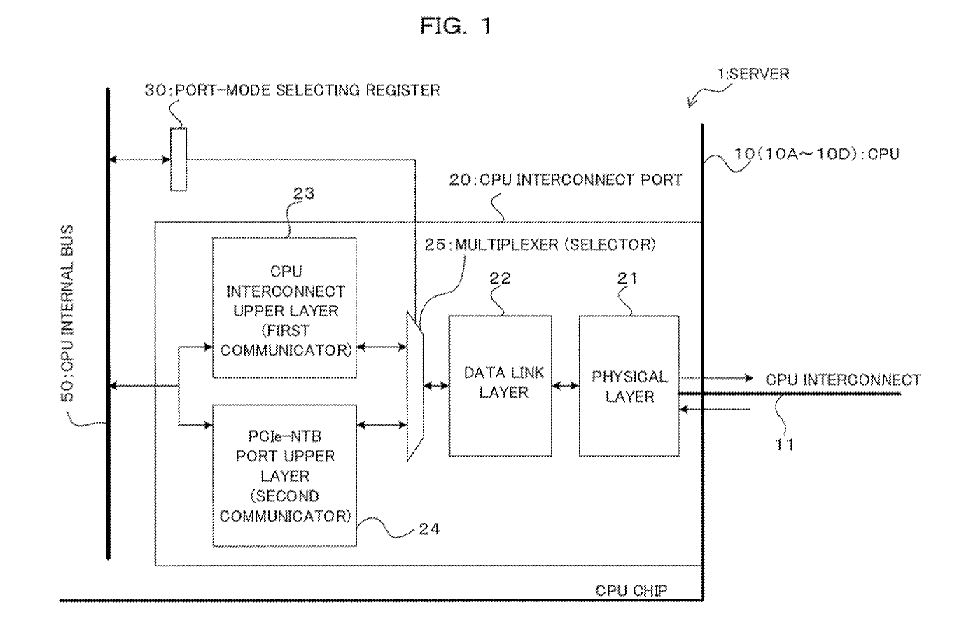

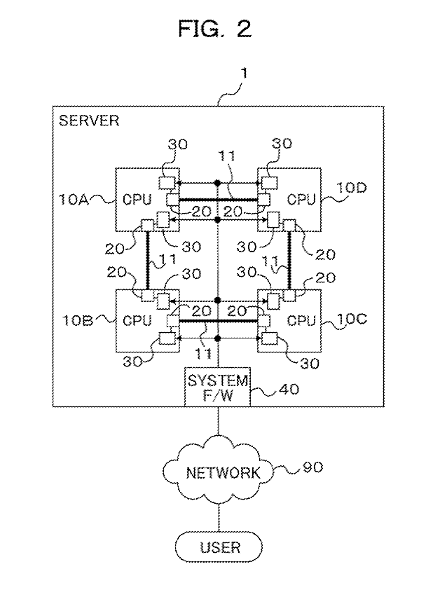

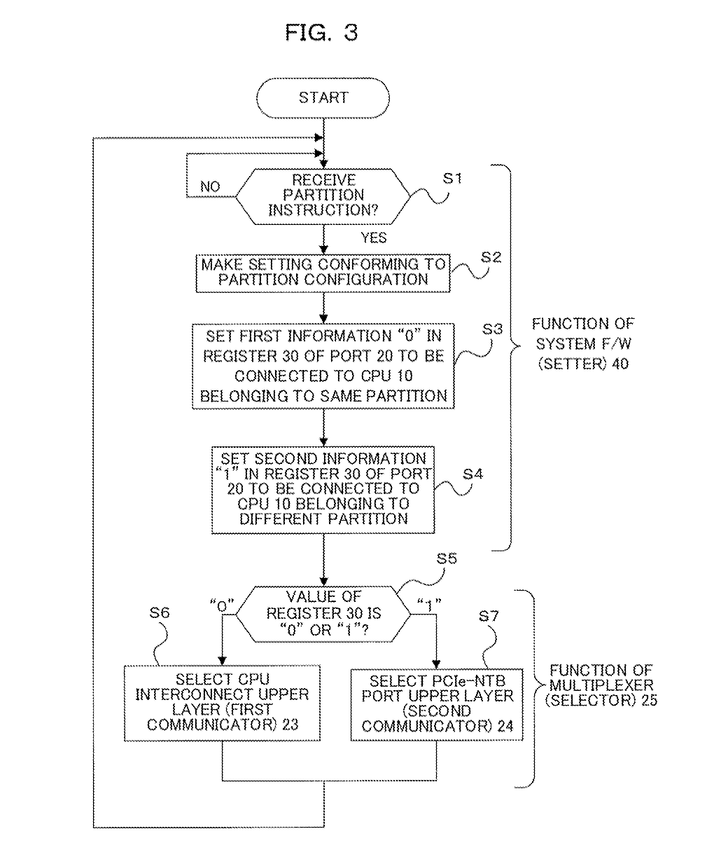

First of all, description will now be made in relation to the configuration and the function of an information processing apparatus (server) 1 according to the first embodiment by referring to FIGS. 1-3. FIG. 1 is a block diagram illustrating the main configuration of the server 1 of the first embodiment; FIG. 2 is a block diagram schematically illustrating the entire configuration of the server 1 applied thereto the main configuration of FIG. 1; and FIG. 3 is a flow diagram (steps S1-S7) denoting functions of a system firmware (setter) 40 of FIG. 2 and a multiplexer (selector) 25 of FIG. 1.

In the server 1 illustrated in FIGS. 1 and 2, four CPUs (processors) 10A-10D are installed. One of the four CPUs is specified by one of the reference numbers 10A-10D, but an arbitrary CPU is represented by the reference number 10. A CPU 10 is point-to-point connected to another CPU 10 by means of QPI or HT. Each CPU 10 includes two CPU interconnect ports 20 and the four CPUs 10A-10D are connected into a ring topology via the CPU interconnect ports 20 and CPU interconnect lines 103.

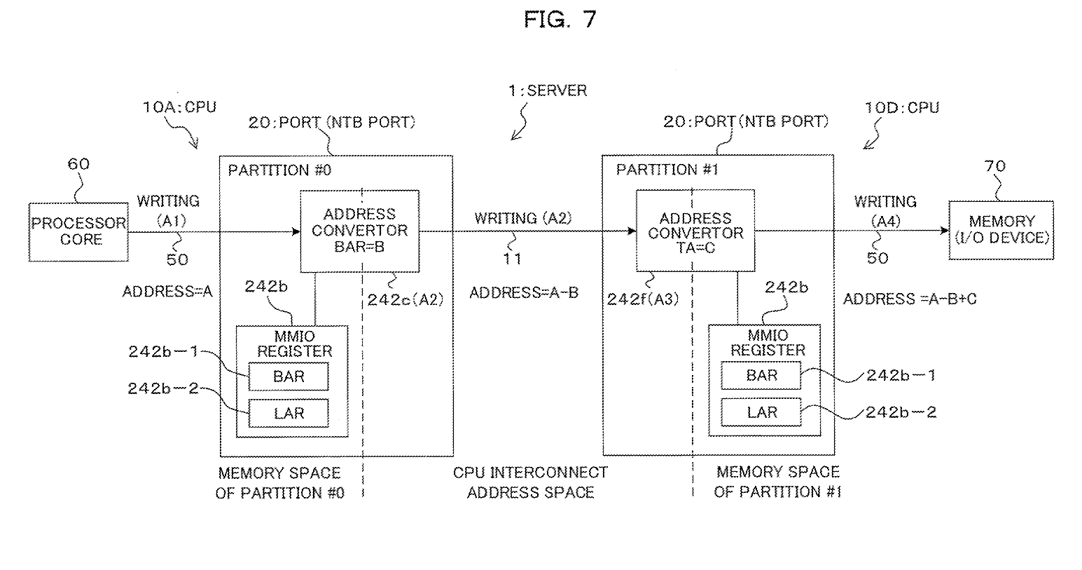

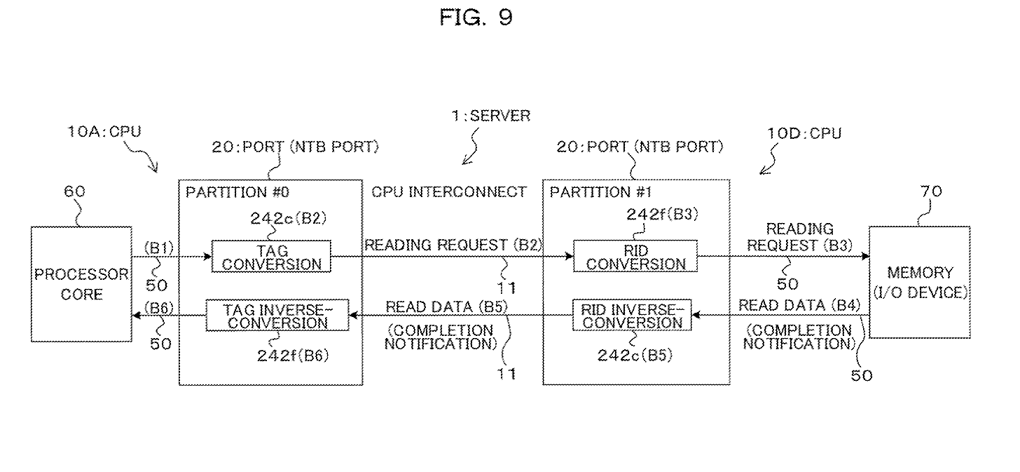

In each CPU 10, the CPU interconnect ports (hereinafter, sometimes simply refers to as “port”) 20 are each connected to a processor core 60 (see FIGS. 7, 9, and 10) and a memory or an Input/Output (I/O) device 70 (see FIGS. 7 and 9) via a CPU internal bus 50.

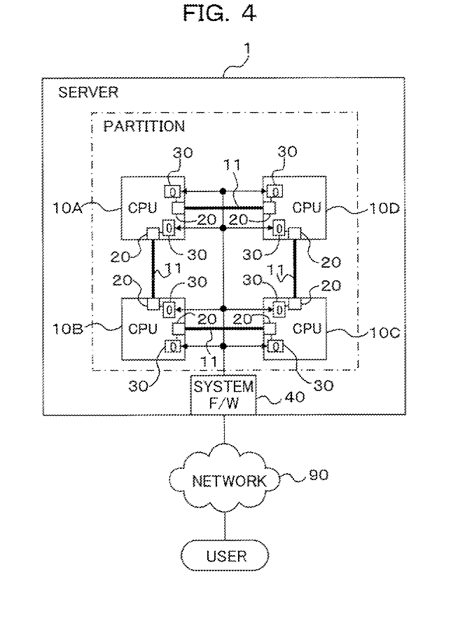

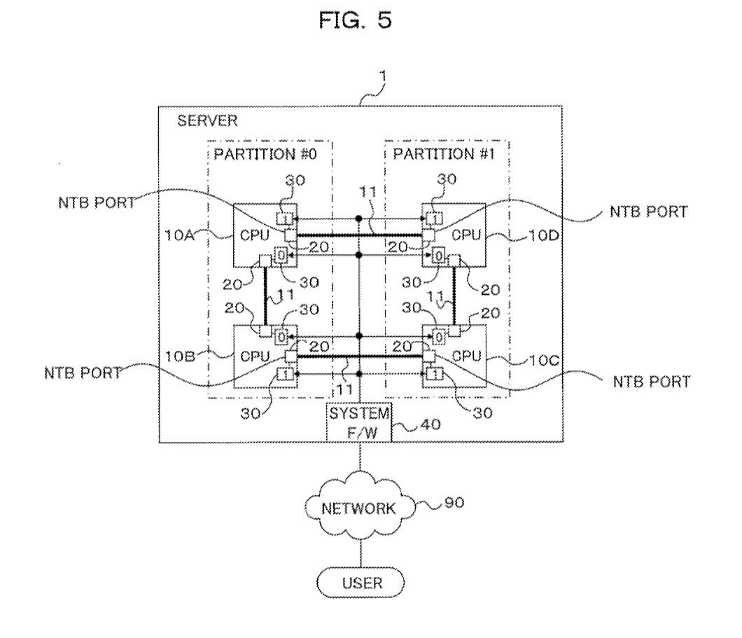

The server 1 has a physical partitioning function, and includes system firmware (F/W; setter) 40 that makes setting on the four CPUs 10A-10D in conformity to the partition configuration (see FIGS. 2, 4, and 5). The system F/W 40 is configured to be operable by the user via a network 90. Furthermore, a port-mode selecting register 30 (hereinafter, sometimes simply referred to as “register”) is provided to each of the two ports 20 and is mounted on the chip of the corresponding CPU 10. A register 30 sets the operation mode of the port 20 and is set therein the physical partition configuration instructed by the user and first or second information to be detailed below with reference to FIGS. 4 and 5.

The ports 20 of each CPU 10 are mounted on the chip of the CPU 10 and are connected to other CPUs 10 via the CPU interconnect lines 11 to communicate with the other CPUs 10. In each port 20, a physical layer 21, a data link layer 22, a CPU interconnect upper layer 23, a PCIe-NTB port upper layer 24, and a multiplexer 25 are disposed between the CPU interconnect line 11 and the CPU internal bus 50.

In each port 20, the physical layer 21, the data link layer 22, and the CPU interconnect upper layer 23 are existing elements disposed between the CPU interconnect line 11 and the CPU internal bus 50. The port 20 of the first embodiment further includes the PCIe-NTB port upper layer 24 and the multiplexer 25 in addition to the above existing elements.

Here, the CPU interconnect upper layer 23 at a higher level than the data link layer 22 functions as a first communicator that communicates with the CPU 10 belonging to the partition on which the port 20 is mounted. For this function, the CPU interconnect upper layer 23 causes the CPU interconnect port 20 to function as a port to carry out communication with the other CPU 10 belonging to the same partition to share the memory space of all the memory accesses.

The PCIe-NTB port upper layer 24 is disposed in parallel with the CPU interconnect upper layer 23 and functions as a second communicator that communicates with a CPU 10 belonging to a different partition from the partition on which the port 20 is mounted. For this function, the PCIe-NTB port upper layer 24 causes the CPU interconnect port 20 to function as a Non-Transparent Bridge (NTB) port of a PCI device. An NTB port conducts communication with a CPU 10 belonging to another partition which communication is explicitly instructed by the processor core 60 serving as the CPU 10 that the port 20 belongs to.

The multiplexer 25 is interposed between the parallel upper layers 23 and 24 and the data link layer 22. The multiplexer 25 selects one of the CPU interconnect upper layer 23 and the PCIe-NTB port upper layer 24 in accordance with the setting made by the system F/W 40 and causes the selected upper layer (communicator) 23 or 24 to communicate with another CPU 10.

Upon receipt of an instruction related to physical partitioning from the user via the network 90 (see YES route of step S1 in FIG. 3), the system F/W 40 makes setting on the four CPUs 10A-10D in conformity to the partition configuration of the received instruction (see step S2 of FIG. 3). At that time, as illustrated in, for example, FIG. 4 or 5, the system F/W 40 sets first or second information into the register 30 provided for each port 20 (steps S3 and S4 of FIG. 3). The first information is a value indicating that the CPU to be connected to the port 20 belongs to the same partition and being, for example, “0”; and the second information is a value indicating that the CPU to be connected to the port 20 belongs to a different partition and being, for example, “1”.

If the first information “0” is set in the register 30 (see the “0” route of step S5 in FIG. 3), the multiplexer 25 switches the data path to select the CPU interconnect upper layer 23 and causes the port 20 to function as a CPU interconnect port (see step S6 of FIG. 3). In contrast, if the second information “1” is set in the register 30 (see the “1” route of step S5 in FIG. 3), the multiplexer 25 switches the data path to select the PCIe-NTB port upper layer 24 and causes the port 20 to functions as an NTB port (see step S7 of FIG. 3).

(1-2) Basic Operation and Effects of the First Embodiment:

Next, description will now be made in relation to basic operation of the server 1 having the above configuration by referring to FIGS. 4 and 5.

FIG. 4 is a block diagram illustrating the single-partitioned state of the server 1. Under the state of FIG. 4, since the four CPUs 10A-10D belong to the same partition, the system F/W 40 sets the first data “0” in all the registers 30 of the four CPUs 10A-10D. This setting causes the multiplexer 25 to switch the data paths to select the CPU interconnect upper layer 23, so that all the ports 20 function as normal CPU interconnect ports. Accordingly, all the ports 30 carry out communication with another CPU 10 belonging to the same partition to share the memory space of all the memory accesses.

FIG. 5 is a block diagram illustrating a two-partitioned state of the server 1. Under the state of FIG. 5, the server 1 is divided into two physical servers by the physical partitioning function. Specifically, the CPUs 10A and 10B are allocated to partition #0 and the CPUs 10C and 10D are allocated to the different partition #1.

In this case, the system F/W 40 sets the first information “0” into the registers 30 corresponding to the ports 20 that connect the CPUs 10A and 10B belonging to the same partition #0 to each other. This setting causes the multiplexers 25 to switch the data paths to select the CPU interconnect upper layers 23 in the corresponding ports 20, so that the ports 20 function as normal CPU interconnect ports. Accordingly, communication is carried out to share the memory space of all the memory accesses between the CPUs 10A and 10B belonging to the same partition. The CPUs 10C and 10D belonging to the same partition “1” undergo the same setting and selection as the above, so that communication is carried out to share the memory space of all the memory accesses between the CPUs 10C and 10D.

On the other hand, the system F/W 40 sets the second information “1” into the registers 30 corresponding to the ports 20 that connect the CPU 10A belonging to the partition #0 to the CPU 10D belonging to the different partition #1. This setting cause the multiplexers 25 to switch the data path to select the PCIe-NTB port upper layers 24 in the corresponding ports 20, so that the ports 20 function as NTB ports. In other words, this makes it possible to use a CPU interconnect port 20, which is ordinarily unused under this status, as an NTB port. Accordingly, through the NTB ports, communication explicitly instructed by the processor core 60 serving as the CPU 10A or 10D is carried out between the CPUs 10A and 10D belonging to the different partitions #0 and #1, respectively. The CPUs 10B and 10C belonging to the different partitions #0 and #1, respectively, undergo the same setting and selection as the above, so that communication explicitly instructed by the processor core 60 serving as the CPU 10B or 10C is carried out between the CPUs 10B and 10C.

As described above, a communication path can be established to a port 20 and another CPU 10 by selecting the PCIe-NTB port upper layer 24, and conducting communication, functioning the port 20, which has been unused, as an NTB port. The communication path established in the above manner can be used as at least one of a memory mirroring path and a failover path.

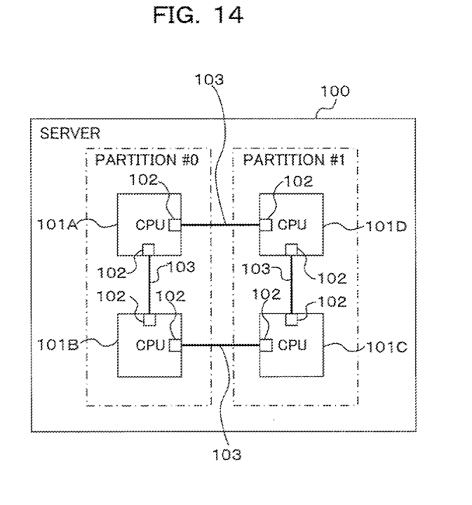

As described above, in the example of FIG. 14, while the server 100 is operating under a state where the server 1 is divided into two physical servers by the partitioning function, two CPUs 101 of the server 100 are allocated to the respective different partitions #0 and #1. Under this state, the CPU interconnect (i.e., the ports 102 and the line 103) that point-to-point connects the two CPU 101 is normally unused.

In contrast, the server 1 of the first embodiment allows the CPU interconnect port 20, which has conventionally been unused when CPUs belonging to different partitions are connected, to function as an NTB port of a PCI device. Thereby, a communication path can be established between the CPUs 10A and 10D or between the CPUs 10B and 10C belonging to the different partitions #0 and #1, respectively, and used as a memory mirroring path or a failover path between different partitions. Consequently, using the CPU interconnect (the ports 20 and the lines 11) that has not been used can efficiently achieve communication between the CPUs 10, 10 belonging to different partitions.

As described above, an NTB port exerts a function of sharing data between two different partitions or hosts according to the PCI specification, has a memory-mapped space in the port, and allows data communication between the partitions or between the hosts by using the space.

(1-3) Detailed Configuration and Operation of the PCIe-NTB Port Upper Layer (Second Communicator):

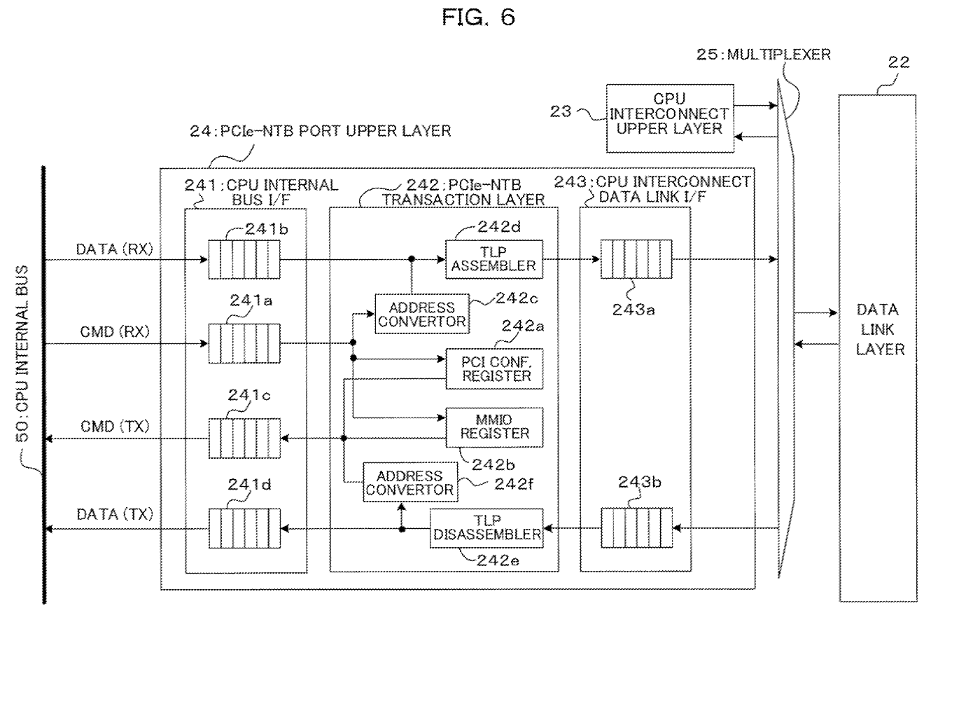

Next, description will now be made in relation to the detailed configuration (interior configuration) of the PCIe-NTB port upper layer (second communicator) 24 which achieves such an NTB port by referring to FIGS. 6-11.

FIG. 6 is a block diagram illustrating a detailed configuration of the PCIe-NTB port upper layer 24. As illustrated in FIG. 6, the PCIe-NTB port upper layer 24 includes a CPU internal bus interface (I/F) 241, a PCIe-NTB transaction layer 242, and a CPU interconnect data link interface (I/F) 243.

The CPU internal bus I/F (first interface) 241 is connected to the processor core 60 via the CPU internal bus 50. The CPU internal bus I/F 241 carries out cache protocol control and carries out data communication between data (DATA and CMD (command)) on the side of processor core 60 and data conforming to the PCIe specification on the side of transaction layer 242. In other words, the CPU internal bus I/F 241 exerts the function of dividing and binding data having a cache line size on the side of processor core 60 into data of the PCIe payload size on the side of the transaction layer 242. Further, the CPU internal bus I/F 241 exerts the function of dividing and binding data having a PCIe payload size on the transaction layer 242 into data of the a cache line size on the side of the processor core 60.

The CPU internal bus I/F 241 includes buffers 241a-241d. The buffer 241a receives a command CMD (RX) from the CPU internal bus 50 (the processor core 60), and outputs the converted command from the buffer 241a to the transaction layer 242. Likewise, the buffer 241b receives data DATA (RX) from the CPU internal bus 50 (the processor core 60), and outputs the converted data from the buffer 241b to the transaction layer 242. The buffer 241c receives a command from the PCIe-NTB transaction layer 242 and transmits the converted command CMD(TX) from the buffer 241c through the CPU internal bus 50 to the processor core 60 or the memory 70. Likewise, the buffer 241d receives data from the transaction layer 242 and transmits the converted data DATA(TX) from the buffer 241d through the CPU internal bus 50 to the processor core 60 or the memory 70.

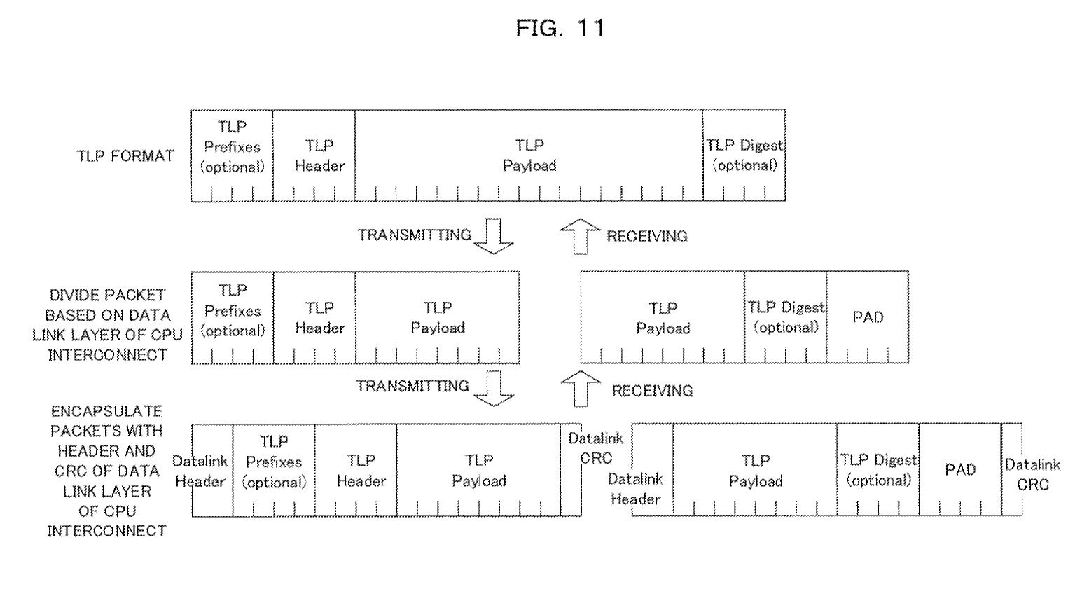

The CPU interconnect data link I/F (second interface) 243 is connected to another CPU via the multiplexer 25, the data link layer 22, the physical layer 21, and the CPU interconnect line 11. The CPU interconnect data link I/F 243 divides and rebuilds a Transaction Layer Packet (TLP) generated by the transaction layer 242. Since the packet length of a TLP is not always the same as the maximum packet length defined by the CPU interconnect, the transaction layer 242 divides and binds a TLP as required. Packet division and encapsulation of a TLP will be detailed below in the following (1-6) by referring to FIG. 11.

The CPU interconnect data link I/F 243 includes buffers 243a and 243b. The buffer 243a receives a TLP from the transaction layer 242 and transmits the divided or bound packet from the buffer 243a through the multiplexer 25, the data link layer 22, the physical layer 21, and the CPU interconnect line 11 to another CPU 10. The buffer 243b receives a packet from another CPU 10 and transmits a TLP obtained by dividing or binding from the buffer 243b to the transaction layer 242.

The PCIe-NTB transaction layer 242 is arranged between the CPU internal bus I/F 241 and the CPU interconnect data link I/F 243, and carries out assembling/disassembling of a TLP and address conversion between a memory space of the partition #0 or #1 and a CPU interconnect address space (see FIG. 7). For this purpose, the transaction layer 242 includes a PCI configuration register 242a, an MMIO register 242b, an address convertor 242c, a TLP assembler 242d, a TLP disassembler 242e, and an address convertor 242f.

The PCI configuration register 242a is a register conforming to the PCIe specification.

The MMIO register 242b includes the following six types of registers 242b-1 to 242b-6 that are to be described in the following (1-4) and (1-5) by referring to FIGS. 7, 9, and 10:

base address register (BAR; address converting register) 242b-1;

limit address register (LAR; address converting register) 242b-2;

transmitting doorbell register (transmitting interrupting register) 242b-3;

receiving doorbell register (receiving interrupting register) 242b-4;

transmitting scratchpad register (transmitting exchange information register) 242b-5; and

receiving scratchpad register (receiving exchange information register) 242b-6.

The address convertor 242c carries out address conversion on data to be transmitted to another CPU 10 on the basis of a command from the processor core 60 and the value of the MMIO register 242b as to be detailed in (1-4) by referring to FIGS. 7-9.

The TLP assembler 242d generates a TLP containing data to be transmitted to another CPU 10 on the basis of information obtained by the address convertor 242c, and outputs the generated TLP to the CPU interconnect data link I/F 243.

The TLP disassembler 242e disassembles a TLP received from another CPU 10, thereby obtains address information and received data. The TLP disassembler 242e outputs the address information to the address convertor 242f while outputs the received data to the address 241 (buffer 241d).

The address convertor 242f carries out address conversion on the address information received from the TLP disassembler 242e on the basis of the value of the MMIO register 242b as to be detailed in (1-4) below by referring to FIGS. 7-9, and outputs the result of the conversion in the form of a command to the CPU internal bus I/F 241 (buffer 241c).

Here, the operation of the PCIe-NTB port upper layer 24 having the above configuration will now be briefly described.

When the PCIe-NTB port upper layer 24 uses the port 20 as an NTB port and transmits data to another CPU 10 through the port 20, the CPU internal bus I/F 241 converts data to the other CPU 10 to conform to the PCI specification. Then the transaction layer 242 generates a TLP on the basis of the data from the CPU internal bus I/F 241. After that, the CPU interconnect data link I/F 243 converts the TLP from the transaction layer 242 into a packet confirming to the specification (CPU interconnect) for communication between the port 20 and another CPU 10.

When the PCIe-NTB port upper layer 24 uses the port 20 as an NTB port and receives data from another CPU 10 through the port 20, the CPU interconnect data link I/F 243 converts the packet from the other CPU 10 into a TLP. Then the transaction layer 242 generates data conforming to the PCI specification on the basis of the TLP from the CPU interconnect data link I/F 243. After that, the CPU internal bus I/F 241 converts the data from the transaction layer 242 into data destined for the processor core 60 or the memory (I/O device) 70.

(1-4) Address Conversion:

Next, description will now be made in relation to the address converting function of the address convertors 242c and 242f of the PCIe-NTB transaction layer 242 by referring to FIGS. 7-9. Since the physical partitions #0 and #1 have respective memory spaces, an NTB port generally requires an address converting function. The address converting function is achieved by the address convertors 242c and 242f in the PCIe-NTB transaction layer 242 on the basis of the values set in the MMIO register 242b (registers 242b-1, 242b-2).

First of all, description will now be made in relation to procedures (A1)-(A4) of forwarding write data from the processor core 60 of the partition #0 to the memory (I/O device) 70 of the partition #1 using the above address converting function by referring to FIG. 7. FIG. 7 is a block diagram illustrating the address converting function of the address convertors 242c and 242f of the PCIe-NTB transaction layer 242 illustrated in FIG. 6. FIG. 7 illustrates forwarding of write data from the processor core 60 of the CPU 10A belonging to the partition #0 to the memory 70 of the CPU 10D belonging to the partition #1.

(A1) The processor core 60 of the sender partition #0 writes data destined for the memory 70 of the partition #1 to be directed to the BAR 242b-1 of the partition #0. The address at this step is assumed A, which is an address belonging to the memory space of the partition #0.

(A2) the address convertor 242c of the PCIe-NTB port upper layer 24 of the partition #0 confirms that the writing address is in the range between the lower limit and the upper limit and carries out address conversion. Here, the setting value (lower limit) of the BAR 242b-1 is assumed to be B, and the address convertor 242c confirms that the address A is equal to or more than the setting value B and is also equal to or less than the upper limit set in the LAR 242b-2 and then outputs the value A-B as the address after the conversion. The address A-B after the conversion is address belonging to the CPU interconnect address space.

(A3) Upon receipt of data, the address convertor 242f of the PCIe-NTB port upper layer 24 of the partition #1 converts the address A-B of the received data into an address of the memory space of the partition #1. The setting value (lower limit, target address (TA)) of the BAR 242b-1 of the partition #1 is assumed to be C, and the address after the conversion is A−B+C, which is an address belonging to the memory space of the partition #1.

(A4) The PCIe-NTB port upper layer 24 of the partition #1 executes Direct Memory Address (DMA) to the memory (I/O device) 70 through the CPU internal bus 50 using A−B+C as an address.

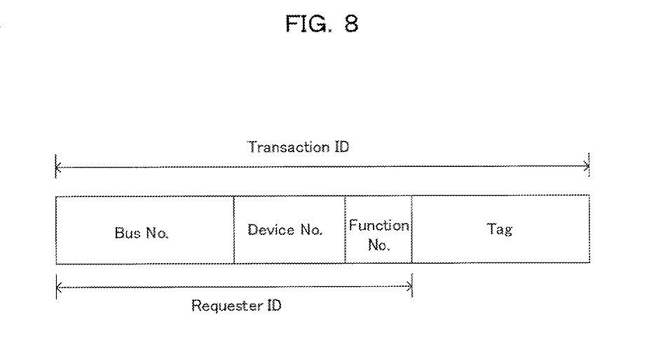

Next, description will now be made in relation to procedures (B1)-(B6) of a reading access (Read forwarding) from the processor core 60 of the partition #0 to the memory (I/O device) 70 of the partition #1 using the above address converting function by referring to FIGS. 8 and 9. FIG. 8 is a diagram illustrating the contents of a transaction identification (ID) and FIG. 9 is a block diagram illustrating functions of tag conversion/inverse-conversion and transaction ID conversion/inverse-conversion by the address convertor 242f in the transaction layer 242 of FIG. 6. FIG. 9 illustrates a reading access from the processor core 60 of the CPU 10A belonging to the partition #0 to the memory 70 of the CPU 10D belonging to the partition #1.

In a reading access (Read forwarding), the address conversion on reading-target address is conducted in the same manner as the above procedures (A1)-(A4) described with reference to FIG. 7 except for the forwarding direction. A reading access forwards reading data from partition #1 to the partition #0. The transaction ID of reading data is one-to-one associated with the transaction ID of a reading request (Read Request) so that the processor core 60 of the requester partition #0 can recognize that a response from the partition #1 is a response to which request. As illustrated in FIG. 8, a transaction ID consists of a requester ID and a tag. A requester ID (RID) is information of the source of the reading request and includes a bus number, a device number, and a function number. A tag is, for example, a sequential number generated for each request by the processor core 60. Hereinafter, the procedure of converting a requester ID (RID) and a tag will now be described in (B1)-(B6) and FIG. 9.

(B1) The processor core 60 of the sender partition #0 issues a reading request to the PCIe-NTB port upper layer 24 of the partition #0 with the requester ID of the processor core 60 itself.

(B2) Upon receipt of the reading request, the PCIe-NTB port upper layer 24 of the partition #0 causes the address convertor 242c to carry out tag conversion that replaces the tag in the received transaction ID so that the reading request that the PCIe-NTB port upper layer 24 itself has received can be univocally identified. This makes the PCIe-NTB port upper layer 24 possible to univocally recognize the association of the reading request with reading data. The transaction ID before the tag conversion and the value of the tag after the tag conversion are stored in a first table (not illustrated) in association with each other. After that, the PCIe-NTB port upper layer 24 of the partition #0 forwards a reading request containing transaction ID after undergoing the tag conversion to the PCIe-NTB port upper layer 24 of the partition #1.

(B3) The address convertor 242f of the PCIe-NTB port upper layer 24 of the partition #1 receives the reading request and then carries out RID conversion that replaces the requester ID (the ID of the processor core 60 of the partition #0) in the transaction ID of the received reading request with the requester ID on the side of the partition #1. The requester ID on the side of the partition #1 is used when the memory 70 returns a response (read data/completion notification; Read DATA/Completion) to the reading request to the PCIe-NTB port upper layer 24 of the partition #1. At this time, in the PCIe-NTB port upper layer 24 of the partition #1, the transaction ID before undergoing the RID conversion is stored in a second table (not illustrated).

(B4) The memory (I/O device) 70 of the partition #1 replies to the PCIe-NTB port upper layer 24 with the reading data (completion notification).

(B5) The address convertor 242c in the PCIe-NTB port upper layer 24 of the partition #1 carries out RID inverse-transaction that retrieves the transaction ID before the RID conversion in the second table using the tag as the key and replaces the requester ID of the received reading data with the retrieved original requester ID. After that, the PCIe-NTB port upper layer 24 forwards the reading data containing the transaction ID after undergoing the RID inverse-conversion to the PCIe-NTB port upper layer 24 of the partition #0.

(B6) The address convertor 242f in the PCIe-NTB port upper layer 24 of the partition #0 carries out tag inverse-conversion that retrieves the original tag before the tag conversion from the first table using the tag included in the transaction ID of the received reading data as a key and replaces the tag of the transaction ID with the retrieved original tag. After that, the PCIe-NTB port upper layer 24 forwards the reading data containing the transaction ID after undergoing the tag inverse-conversion to the processor core 60 through the CPU internal bus 50.

(1-5) Doorbell Function and Scratchpad Function:

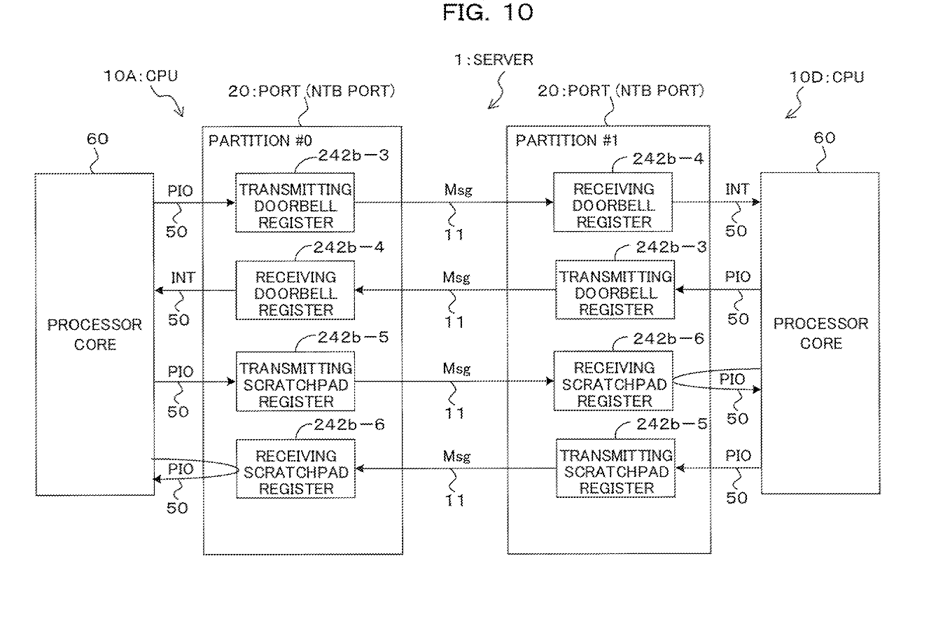

Next, description will now be made in relation to a Doorbell function and a Scratchpad function that the PCIe-NTB transaction layer 242 has by referring to FIG. 10. FIG. 10 is a block diagram illustrating the Doorbell function and the Scratchpad function exerted by the transaction layer 242 of FIG. 6.

To accomplish the communication between the CPUs 10 (e.g., CPUs 10A and 10D) belonging to different partitions #0 and #1, an NTB port (PCIe-NTB transaction layer 242) generally has the Doorbell function and the Scratchpad function.

(1-5-1) Doorbell Function:

The Doorbell function is a function for interrupting (INT) that causes the processor core 60 in either one of the partitions #0 and #1 to interrupt the processor core 60 of the other of the partitions #1 and #0. The sender processor core 60 carries out writing into the transmitting doorbell register 242b-3 of the sender PCIe-NTB transaction layer 242 by means of Programmed I/O (PIO). Upon receipt of the writing, the sender PCIe-NTB transaction layer 242 generates a message packet (Msg; TLP) and transmits the generated message packet to the receiver PCIe-NTB transaction layer 242. This message packet is uniquely defined by using the scheme of Vender Defined Message of the PCIe specification. If the received message packet relates to the Doorbell function, the receiver PCIe-NTB transaction layer 242 determines that the received contents in the message packet is a doorbell. Then, the receiver PCIe-NTB transaction layer 242 carries out writing into the receiving doorbell register 242b-4 and notifies the interruption (INT) to the receiver processor core 60.

In other words, when the processor core 60 writes an interrupting instruction on another CPU 10 into the transmitting doorbell register 242b-3, the PCIe-NTB transaction layer 242 (NTB port) generates a TLP that instructs interruption and forwards the generated TLP to the other CPU 10. On the other hand, when another CPU 10 writes an interrupting instruction on the processor core 60 into the receiving doorbell register 242b-4, the PCIe-NTB transaction layer 242

(NTB port) interrupts the processor core 60.

(1-5-2) Scratchpad Function:

The Scratchpad function is used for exchanging several-byte data between the processor cores 60 of the partitions #0 and #1. The sender processor core 60 writes exchange information into the transmitting scratchpad register 242b-5 of the sender PCIe-NTB transaction layer 242 by means of PIO. The sender PCIe-NTB transaction layer 242, into which the exchange information has been written, generates a message packet (Msg; TLP) and transmits the generated message packet to the receiver PCIe-NTB transaction layer 242. This message packet is uniquely defined by using the scheme of Vender Defined Message of the PCIe specification. If the received message packet relates to the Scratchpad function, the receiver PCIe-NTB transaction layer 242 determines that the received contents in the message packet is a scratchpad. Then the receiver PCIe-NTB transaction layer 242 reflects the contents (i.e., exchange information) of the message packet in the receiving scratchpad register 242b-6. The receiver processor core 60 can grasp the exchange information from the sender processor core 60 by reading the contents in the receiving scratchpad register 242b-6 by means of PIO.

Namely, when the processor core 60 writes exchange information to be exchanged with another CPU 10 into the transmitting scratchpad register 242b-5, the PCIe-NTB transaction layer 242 (NTB port) generates a TLP containing the exchange information and forwards the generated TLP to the other CPU 10. In contrast, exchange information to be exchanged with the processor core 60 is written into the receiving scratchpad register 242b-6 by another CPU 10, the PCIe-NTB transaction layer 242 (NTB port) notifies the exchange information in the receiving scratchpad register 242b-6 in response to a query (PIO) from the processor core 60.

(1-6) Division and Encapsulation of a TLP:

Next, description will now be made in relation to division and encapsulation of a packet by the CPU interconnect data link I/F (second interface) 243 by referring to FIG. 11. FIG. 11 is a diagram illustrating division and encapsulation of a packet by the CPU interconnect data link I/F 243 of FIG. 6.

The CPU interconnect data link I/F 243 in the sender NTB port carries out the following process. First of all, the CPU interconnect data link I/F 243 receives a TLP conforming to the PCIe from the upstream PCIe-NTB transaction layer 242. The format of a TLP is illustrated on the top row of FIG. 11. The CPU interconnect data link I/F 243 divides and pads the received TLP into a packet size (packet length) of the CPU interconnect and thereby generates one or more packets each having a packet size of the CPU interconnect.

FIG. 11 illustrates division and encapsulation of a packet when the received TLP exceeds the packet size of the CPU interconnect. First of all, the CPU interconnect data link I/F 243 divides the TLP on the top row of FIG. 11 into two packets as illustrated on the middle row of FIG. 11. One (the left) packet has a size the same as the packet size of the CPU interconnect while the other (the right) packet has a size smaller than the packet size of the CPU interconnect. Therefore, the other packet is pad so as to have a size the same as the packet size of the CPU interconnect as illustrated on the right part of the middle row of FIG. 11.

In the example of FIG. 11, the CPU interconnect data link I/F 243 attaches a header (Header) and a Cyclic Redundancy Check (CRC) of a data link layer of the CPU interconnect respectively to the front end and the rear end of each of the two packets divided as illustrated on the bottom row of FIG. 11. Thereby, each packet is encapsulated. On the other hand, the CPU interconnect data link I/F 243 of the receiver NTB port rebuilds a TLP conforming to the PCIe from packets of the data link layer by executing the reverse process of the above process of the division and encapsulation of a packet performed in the sender NTB port.

(2) Information Processing Apparatus (Server) of a Second Embodiment:

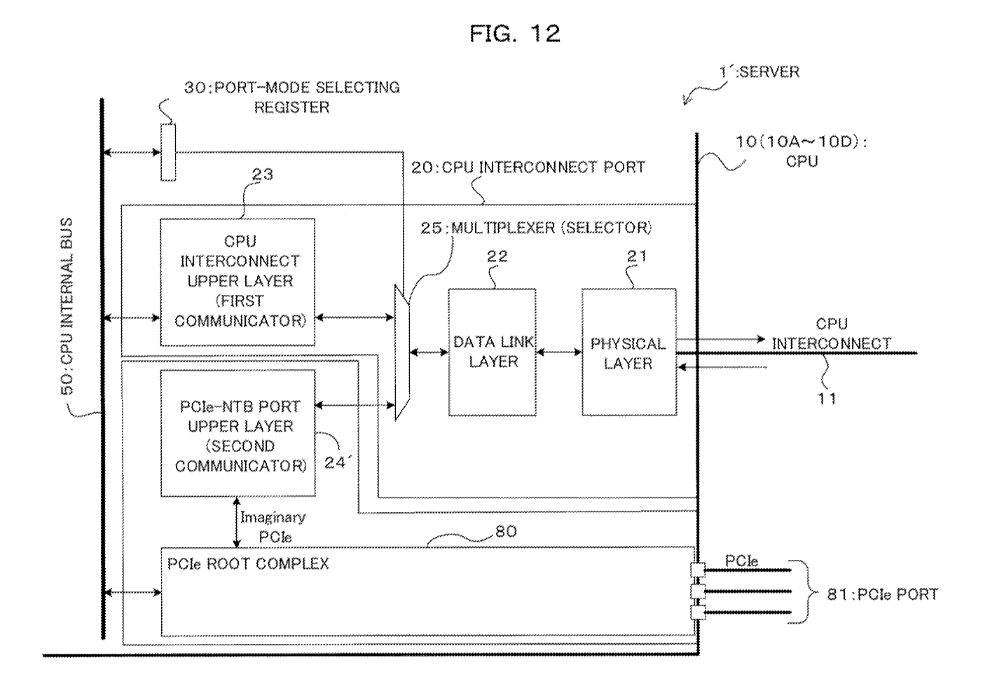

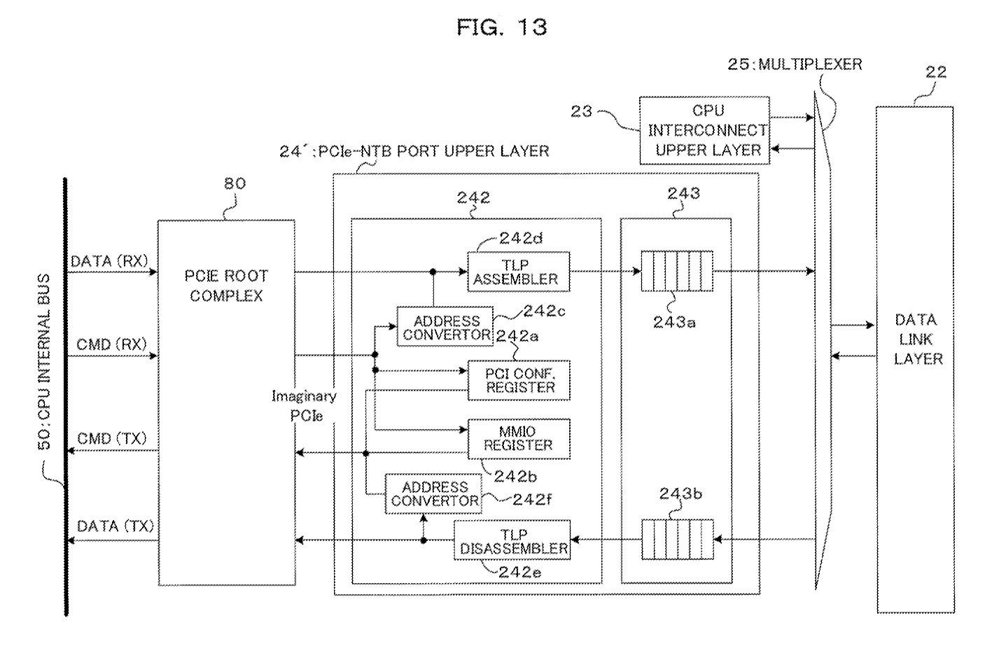

Next, description will now be made in relation to an information processing apparatus (server) 1′ according to a second embodiment by referring to FIGS. 12 and 13. FIG. 12 is a block diagram illustrating the main configuration of the server 1′ of the second embodiment; and FIG. 13 is a block diagram illustrating a detailed configuration of a PCIe-NTB port upper layer (second communicator) 24′ of FIG. 12. Hereinafter, like reference numbers in the drawings designate the same or the substantially same elements and parts detailed above, so repetitious description is omitted here.

As illustrated in FIG. 12, each CPU 10 in the server 1′ of the second embodiment includes PCIe ports 81. In cases where the CPU 10 includes PCIe ports 81, the CPU 10 further includes a PCIe root complex 80 disposed between the CPU internal bus 50 and the PCIe ports 81. This case allows the CPU internal bus I/F 241 of the first embodiment to be mounted in the PCIe root complex 80 and to be shared with the PCIe ports 81.

This means that, the second embodiment differs from the first embodiment (the PCIe-NTB port upper layer 24) in the point that as illustrated in FIG. 12, the upstream connection of the PCIe-NTB port upper layer 24′ is the PCIe root complex 80, not the CPU internal bus 50.

As illustrated in FIG. 12, the PCIe-NTB port upper layer 24′ of the second embodiment is connected to the PCIe root complex 80, which makes it possible to omit, as illustrated in FIG. 13, the block of the CPU internal bus I/F 241 included in the first embodiment. The remaining blocks (i.e., the PCIe-NTB transaction layer 242 and the CPU interconnect data link I/F 243) are also included in the PCIe-NTB port upper layer 24′ of the second embodiment likewise the PCIe-NTB port upper layer 24 of the first embodiment.

In cases where the CPUs 10 of the server 1′ of the second embodiment each include the PCIe ports 81 and the PCIe root complex 80, the PCIe root complex 80 exerts the function of the CPU internal bus I/F (first interface) 241 of the first embodiment. Consequently, although having a simpler configuration than that of the first embodiment, the server 1′ of the second embodiment ensures the same advantages as that of the first embodiment.

(3) Others:

Preferred embodiments of the present invention are described as the above. However, the present invention is by no means limited to the foregoing embodiments, and various changes and modification can be suggested without departing from the spirit of the present invention.

In the above first embodiment, the single server 1 includes the four CPUs 10A-10D, but the present invention is not limited to this.

The entire or part of the functions of the above servers 1, 1′ including the CPU interconnect upper layer (first communicator) 23, the PCIe-NTB port upper layers (second communicators) 24, 24′, the multiplexer (selector) 25, and the system F/W (setter) 40 is achieved by a computer (including a CPU, an information processing apparatus, and various terminals) executing a predetermined program.

The program is provided in the form of being stored in a computer-readable recording medium, such as a flexible disk, a CD (e.g., CD-ROM, CD-R, and CD-RW), a DVD (e.g., DVD-ROM, DVD-RAM, DVD-R, DVD-RW, DVD+R, and DVD+RW), and a Blu-ray Disc. In this case, the computer reads the program from the recoding medium, and forwards and stores the read program to and into an internal or external memory device for future use.

According to the foregoing embodiments, communication between processors belonging to different partitions can be efficiently achieved.

All examples and conditional language provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a plurality of processors; and
a setter that makes setting on the plurality of processors in conformity with a partition configuration,
each of the plurality of processors comprising a port being connected to another processor and communicating with the connected other processor,
the port comprising a first communicator that communicates with a processor belonging to a same partition as the processor including the port; a second communicator that communicates with a processor belonging to a different partition from the processor including the port; and a selector that selects a communicator from the first communicator and the second communicator in accordance with the setting of the setter and causes the selected communicator to communicate with the corresponding other processor.

2. The information processing apparatus according to claim 1, wherein:
each of the plurality of the processors further comprises a register that stores therein first information indicating that the other processor belongs to the same partition or second information indicating that the other processor belongs to the different partition, the first information and the second information being set by the setter; and
when the first information is set in the register, the selector selects the first communicator while, when the second information is set in the register, the selector selects the second communicator.

3. The information processing apparatus according to claim 1, wherein the first communicator executes communication with the other processor belonging to the same partition to share a memory space for every memory access.

4. The information processing apparatus according to claim 1, wherein the second communicator executes communication with the other processor belonging to the different partition, the communication being explicitly instructed by a processor core serving as the processor including the port.

5. The information processing apparatus according to claim 4, wherein the second communicator executing the communication causes the port to function as a Non-Transparent Bridge (NTB) port of a Peripheral Components Interconnect (PCI) device.

6. The information processing apparatus according to claim 5, the second communicator comprising:
a first interface connected to the processor core;
a second interface connected to the other processor; and
an NTB transaction layer arranged between the first interface and the second interface, wherein
when the second communicator uses the port as the NTB port to send data to the other processor, the first interface converts the data destined for the other processor into data conforming to a PCI specification; the NTB transaction layer generates a Transaction Layer Packet (TLP) based on the data conforming to the PCI specification and being received from the first interface; and the second interface converts the TLP from the NTB transaction layer into one or more packets conforming to a specification of the communication between the port and the other processor, and
when the second communicator uses the port as the NTB port to receive data from the other processor, the second interface converts a packet from the other processor into a TLP; the NTB transaction layer generates data conforming to the PCI specification and being based on the TLP from the second interface; and the first interface converts the data from the NTB transaction layer to data destined for the processor core or a memory.

7. The information processing apparatus according to claim 6, wherein:
each of the plurality of processors further comprises a PCI port and a root complex; and
the first interface in the second communicator is configured by the root complex.

8. The information processing apparatus according to claim 6, wherein
when the processor core writes an instruction of interrupting on the other processor into a transmitting interrupting register of the NTB transaction layer, the second communicator generates a TLP instructing the interrupting and forwards the generated TLP to the other processor; and
when the other processor writes an instruction of interrupting on the processor core into a receiving interrupting register of the NTB transaction layer, the second communicator instructs the interrupting on the processor core.

9. The information processing apparatus according to claim 6, wherein:
when the processor core writes exchange information to be exchanged with the other processor into a transmitting exchange information register of the NTB transaction layer, the second communicator generates a TLP containing the exchange information and forwards the generated TLP to the other processor; and
when the other processor writes exchange information to be exchanged with the processor core into a receiving exchange information register of the NTB transaction layer, the second communicator notifies the processor core of the exchange information in the receiving exchange information register in response to a query from the processor core.

10. The information processing apparatus according to claim 1, wherein a path between the port and the other processor, the path being established when the second communicator executes the communication, functions as at least one of a memory mirroring path and a failover path.

11. A method for controlling an information processing apparatus including a plurality of processors, each of the plurality of processors including a port being connected to another processor and communicating with the connected other processor, by making setting on the plurality of processors in conformity with a partition configuration, the method comprising:
in the port including a first communicator that communicates with a processor belonging to a same partition as the processor including the port and a second communicator that communicates with a processor belonging to a different partition from the processor including the port,
selecting a communicator from the first communicator and the second communicator in accordance with the setting; and
causing the selected communicator to communicate with the corresponding other processor.

12. The method according to claim 11, wherein:
each of the plurality of the processors further includes a register being set therein first information indicating that the other processor belongs to the same partition or second information indicating that the other processor belongs to the different partition; and
the method further comprising
when the first information is set in the register, selecting the first communicator, and
when the second information is set in the register, selecting the second communicator.

13. The method according to claim 11, further comprising causing the first communicator to execute communication with the other processor belonging to the same partition in order to share a memory space for every memory access.

14. The method according to claim 11, further comprising causing the second communicator to execute communication with the other processor belonging to the different partition, the communication being explicitly instructed by a processor core serving as the processor including the port.

15. The method according to claim 14, wherein the second communicator executing the communication causes the port to function as a Non-Transparent Bridge (NTB) port of a Peripheral Components Interconnect (PCI) device.

16. The method according to claim 11, wherein a path between the port and the other processor, the path being established when the second communicator executes the communication, functions as at least one of a memory mirroring path and a failover path.
